(19) United States
(12) Patent Application Publication
(10) Pub. No.: US 2006/0141435 A1
(43) Pub. Date: Jun. 29, 2006

(54) Portable karaoke machine

(75) Inventor: Jung-Chieh Chiang, Taichung (TW)

Correspondence Address: NIKOLAI & MERSEREAU, P.A., 900 SECOND AVENUE SOUTH, SUITE 820, MINNEAPOLIS, MN, 55402, US

(73) Assignee: ENHANCE PRECISION ELECTRONICS CO., LTD., Taichung (TW)

(21) Appl. No.: 11/038,815

(22) Filed: Jan. 20, 2005

(30) Foreign Application Priority Data
Dec. 15, 2004 (TW) 093220177

(51) Int. Cl. G09B 5/00

(52) U.S. Cl. 434/307 A

(57) ABSTRACT

A portable karaoke machine has a bottom, a body, a monitor, a control system, an amplifier and a set of wheels. The monitor, the control system and the amplifier are mounted in the body, and the wheels are mounted on the bottom of the body. A convenient way to carry the karaoke machine is provided.

### BACKGROUND OF THE INVENTION

1. Field of Invention

The present invention relates to a karaoke machine, especially to a portable karaoke machine that has multimedia capabilities.

2. Description of the Related Art

The main capabilities of a conventional karaoke machine include providing images and vocal accompaniment. The conventional karaoke machine has an echo synthesizer, an amplifier and a wireless microphone assembly. When the conventional karaoke machine is used, a television and a speaker must be used with the karaoke machine.

The disadvantages of the conventional karaoke machine include the following.

1. The karaoke machine, the television and the speaker set are independent components. When the karaoke machine is used at a location other then its normal location, the television and the speaker must also be taken to the new location, so it is inconvenient for use.

2. Because the television, the speaker set and the karaoke machine are independent components, wires to connect the independent components easily become disorderly, unsightly and entangled.

The portable karaoke machine in accordance with the present invention obviates or mitigates the aforementioned problems.

### SUMMARY OF THE INVENTION

The primary objective of the present invention is to provide a karaoke machine that is portable and is completely self-contained.

To achieve the objective, the portable karaoke machine in accordance with the present invention has a bottom, a monitor, a control system, an amplifier and a set of wheels. The monitor, the control system and the amplifier are mounted in the body, and the wheels are mounted on the bottom. The present invention provides a convenient way to carry the karaoke machine.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a portable karaoke machine in accordance with the present invention;

FIG. 2 is a perspective view of the portable karaoke machine in FIG. 1 with a microphone assembly;

FIG. 3 is a perspective view of the portable karaoke machine in FIG. 1 with a first embodiment of speakers;

FIG. 4 is a perspective view of the portable karaoke machine in FIG. 1 with a second embodiment of speakers;

FIG. 5 is a perspective view of the portable karaoke machine in FIG. 1 with a stereo; and

FIG. 6 is a plan view of the portable karaoke machine in FIG. 1 in a vehicle.

### DETAILED DESCRIPTION OF THE INVENTION

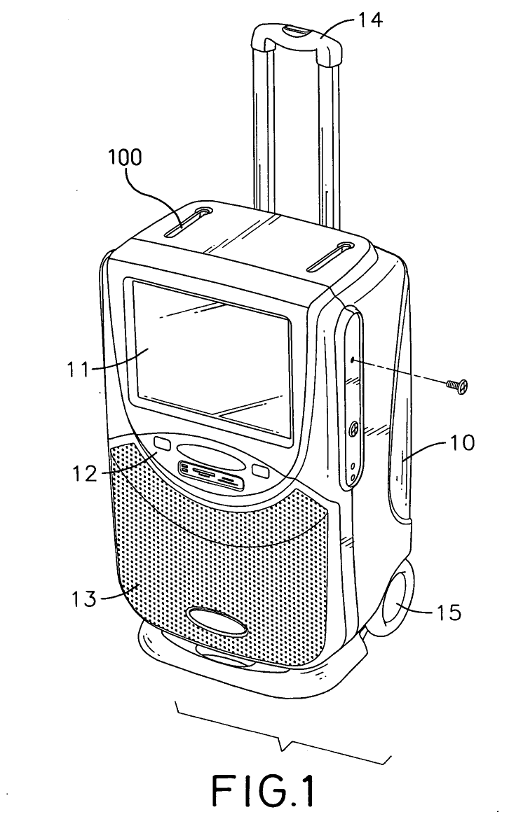

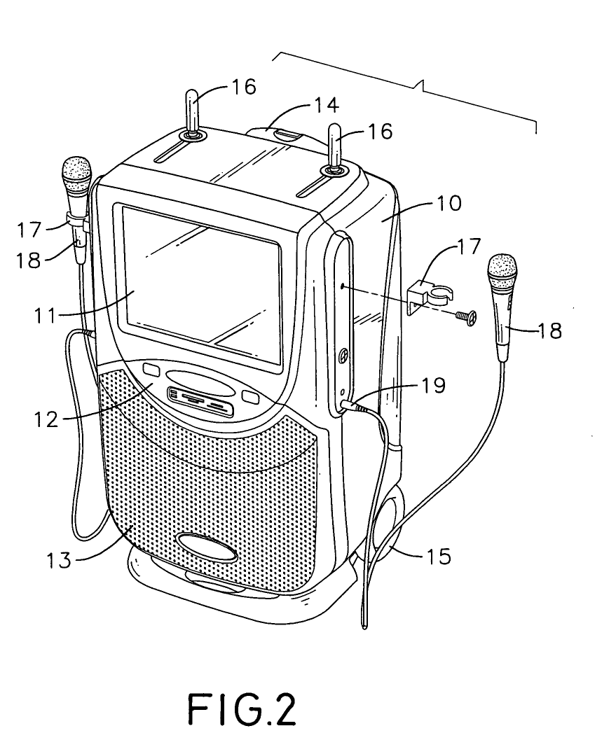

With reference to FIGS. 1 and 2, a portable karaoke machine in accordance with the present invention has a body (10), a monitor (11), a control system (12), an amplifier (13), at least one optional antenna (16), at least one optional microphone bracket (17), an optional microphone assembly, an optional speaker set, an optional stereo (30) and an optional game machine (101).

The body (10) has a top surface, a bottom, a front surface, a rear surface, two side surfaces, at least one optional slot (100), an optional telescopic handle (14) and a set of wheels (15). The at least one slot (100) is defined in the top surface of the body (10). In a preferred embodiment, two slots (100) are defined in the top surface of the body (10). The telescopic handle (14) is mounted on the rear surface of the body (10) and extends from the top surface of the body (10). The set of wheels (15) are mounted on the bottom surface of the body (10). In a preferred embodiment, two wheels (I5) are mounted on the bottom surface near the rear surface of the body (10).

The monitor (11) is mounted in the front surface near the top surface.

The control system (12) is mounted in the front surface of the body (10) below the monitor (11).

The amplifier (13) is mounted in the front surface of the body (10).

The at least one antenna (16) is mounted on the top surface of the body (10) and extends from the at least one slot (100) in the body (10). In a preferred embodiment, two antennas (16) extend respectively from the two slots (100).

The at least one microphone bracket (17) is mounted on one side surfaces of the body (10). In a preferred embodiment, two microphone brackets (17) are mounted respectively on the side surfaces of the body (10).

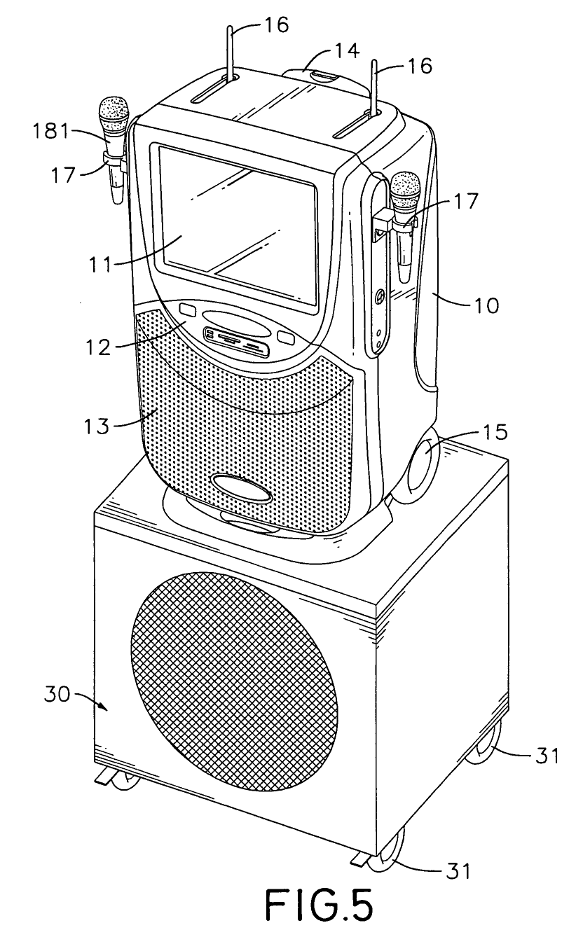

The microphone assembly connects to the body (10) and has at least one microphone (18). The at least one microphone (18) is hooked on the at least one microphone bracket (17). In a preferred embodiment, two microphones (18) hook respectively on the two microphone brackets (17). With reference to FIG. 5, the at least one microphone (18) may be a wireless microphone (181).

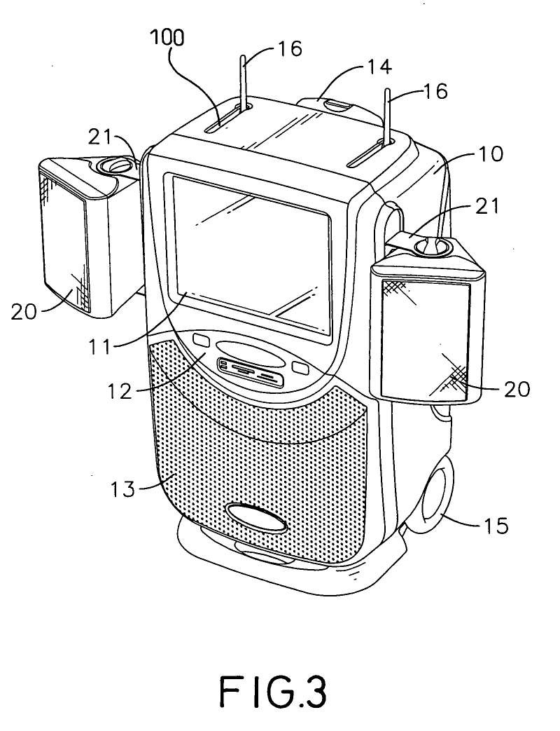

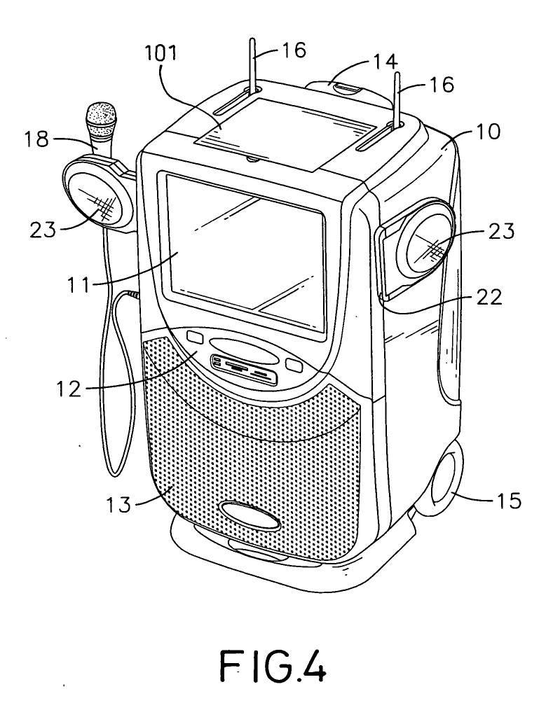

With reference to FIGS. 3 and 4, the speaker set is mounted on the side surface of the body (10). A first embodiment of the speaker set has at least one speaker (20) and at least one mounting bracket (21). The at least one mounting bracket (21) is mounted on the side surface of the body (10) and extends from the side surface. The at least one speaker (20) is mounted on the at least one mounting bracket (21). In a preferred embodiment, two speakers (20) are mounted respectively on two mounting brackets (21). A second embodiment of the speaker set has at least one speaker (23) attached pivotally to the side surface of the body (10). The at least one speaker (23) has a rear surface and a bracket. The bracket is mounted on the rear surface of each speaker (23). In a preferred embodiment, two speakers (23) are mounted respectively on the side surfaces of the body.

Further, the game machine (101) may be mounted on the top surface of the body (10).

With reference to Fig.5, the stereo (30) is mounted on the body (10) and has a bottom and multiple optional wheels (31). The stereo (30) may be mounted on the bottom of the body (10), and the wheels (31) are mounted on the bottom of the stereo (30).

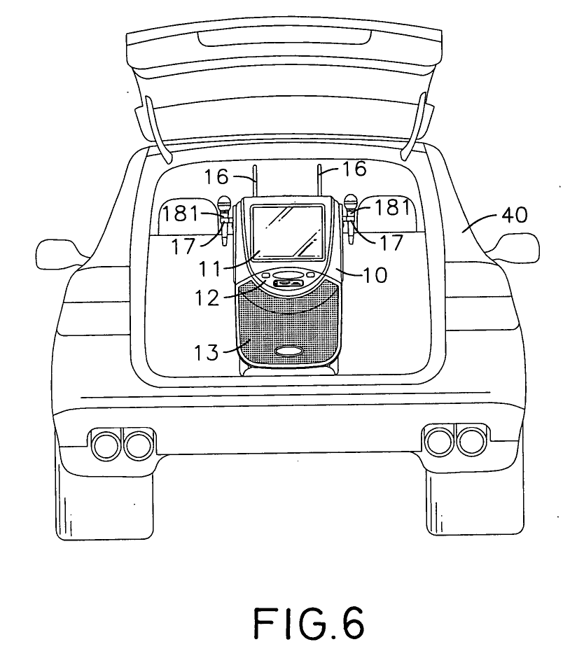

With reference to FIG. 6, the portable karaoke machine can be mounted in a vehicle for convenient use.

The portable karaoke machine has the following advantages.

1. Because the telescopic handle (14) and the wheels (15) mounted on the portable karaoke machine, the portable karaoke machine can be conveniently moved anywhere.

2. The volume of the portable karaoke machine is small and has all karaoke capabilities, so it can be carried easily.

The invention may be varied in many ways by a person skilled in the art. Such variations are not to be regarded as a departure from the spirit and scope of the invention, and all such modifications are intended to be included within the scope of the following claims.

What is claimed is:

1. A portable karaoke machine having
a body having
a top surface,
a bottom,
a front surface,
a rear surface,
two side surfaces, and
a set of wheels mounted on the bottom of the body,
a monitor mounted in the front surface and near the top surface,
a control system set in the front surface of the body, and
an amplifier mounted in the front surface of the body.

2. The portable karaoke machine as claimed in claim 1, wherein the portable karaoke machine further comprises
a microphone assembly having at least one microphone, and
at least one microphone bracket mounted on the side surface of the body, wherein each one of the at least one microphone bracket holds a corresponding one of the at least one microphone.

3. The portable karaoke machine as claimed in claim 2, wherein each one of the at least one microphone is wireless.

4. The portable karaoke machine as claimed in claim 3, wherein the portable karaoke machine further comprises a stereo mounted on the body.

5. The portable karaoke machine as claimed in claim 4, wherein the body further comprises a stereo mounted on the bottom of the body and having a bottom and multiple wheels mounted on the bottom.

6. The portable karaoke machine as claimed in claim 1, wherein the body further comprises a game machine.

7. The portable karaoke machine as claimed in claim 1, wherein the body further comprises a speaker set mounted on the side surface of the body.
